(19) United States
(12) Patent Application Publication
(10) Pub. No.: US 2021/0319506 A1
(43) Pub. Date: Oct. 14, 2021

(54) Computer implemented method for automatically generating fixed-payment variable rate financing

(71) Applicant: Paul Jameson, Washington, DC (US)

(72) Inventor: Paul Jameson, Washington, DC (US)

(21) Appl. No.: 17/226,291

(22) Filed: Apr. 9, 2021

Related U.S. Application Data
(60) Provisional application No. 63/007,530, filed on Apr. 9, 2020.

(51) Int. Cl. G06Q 40/02; G06Q 40/00; G06F 9/451

(52) U.S. Cl. CPC G06Q 40/025; G06F 9/451; G06Q 40/12

(57) ABSTRACT

A computer implemented method of providing variable-rate loans that have a single fixed payment structure across multiple rate periods.

### BACKGROUND INFORMATION

### Field of the Invention

The invention relates to computer-implemented financing methods, and in particular to computer-implemented incentivized loan packages that offer lower rates of interest over a portion of the loan term.

### Discussion of Prior Art

Variable rate and adjustable rate loans are commonly offered to incentivize borrowers in a variety of ways. The most common example is to offer borrowers a lower initial rate that transitions to a higher rate at a later point in time. However, there are also loans that offer a higher rate at first and then lower that rate at a later point in time.

More specifically, borrowers of low-to-high packages receive a low or even zero percent financing rate for a fixed initial period of time (the “promotional period”), after which a significantly higher rate is applied for the remainder of the loan term. These are often attractive to borrowers who hope and plan to repay the principal during that initial rate period, however, when borrowers are unable to repay that original principal in the required timeframe there is a spike in the monthly payments that can be catastrophic for many borrowers. This sudden increase in payment amount at the time of a rate adjustment has been described as “payment shock” by the Consumer Finance Protection Bureau in industry reports. See, e.g. https://www.consumerfinance.gov/documents/6000/cfpb_charm_booklet.doc.

Additionally, in the case of the zero percent loans, not all “0%” loan periods are truly “0%”. Rather, it is common for interest to be charged but deferred during the initial, promotional, period. If the principal is paid during the initial period the interest that has accrued but been deferred is waived and the borrower is not impacted—and might even be unaware. However, if the borrower goes one day past the initial period that accrued interest is added to the outstanding balance, and from that point forward the new interest rate is applied to the entire outstanding amount. In effect, once the promotional period expires the borrower is faced with a two-factor payment increase; first based on the higher interest rate and second based on the higher outstanding balance.

For example, a simple $10,000 loan may be offered with a 0% interest rate and no principal payments required for 12 months followed by a rate of 23.99% over the next 72 months. If the 0% period is actually a deferred-interest period the outstanding balance of the loan when the 12 month promotional period ends is $12,399.00. From then on, based on the new rate and outstanding balance, the borrower must make payments of $326.35 per month for the following 6 years. In this example, assuming the borrower is able to make all payments, the total payout is $23,487.20.

As a result, while these types of loan packages are often appealing the payment shock often cause a significant increase in delinquency rates and, eventually, default rates.

In other scenarios borrowers may not qualify for low initial rates, e.g. those borrowers who have poor credit. For these types of borrowers the opposite scenario may be appealing; while they do not qualify for low rates initially, a variable package may be offered that starts high and over time goes down as payments are made and their credit score rises. Still, in the conventional model the borrower may not be able to afford the high initial payment that comes with the high initial rate even though they may afford the future payments at the lower rate and lower monthly payments.

What is needed, therefore, is a method of providing variable-rate loans that have a single fixed payment structure across multiple rate periods.

### BRIEF SUMMARY OF THE INVENTION

The invention is a computer system implemented method of providing a fixed-payment variable-rate loan package.

The computer system is a conventional system, including a graphical user interface (“GUI”) to receive and/or display variables and inputs to the method and to display the resulting loan rate and payment table. The computer system also has access to a data source, such as a database or a cloud-based storage system, where it is able to store various data during operation of the method.

The variable rates may start relatively low and increase over time, or alternatively, they may start comparatively high and decrease over time. The method is applicable over any periodic payment term, such as, for example, weekly, monthly, or quarterly. The loan may be compounded over any suitable period, often annually but other periods may also be suitable such as, for example, monthly, weekly, or daily.

This fixed-payment variable-rate method may enable the borrowers to benefit from a period, or periods, of low interest. For example, if the low-interest period is an initial, promotional, period the borrower may pay off the principal amount and avoid the higher interest, but it also provides a fixed payment over the lifetime of the loan so that there is no payment spike once the initial promotional period ends if the borrower is not able to pay off the principal. Alternatively, the rate may start relatively high and decrease over time, allowing borrowers benefit from a lower initial payment relative to the conventional model. There may be any number of different rates periods over the entire term of the loan.

For example, on a $10,000 loan that has an 84 month term, the first 12 months being the initial promotional term with a rate of 0% and the remaining 72 months having a rate of 16.99% every month of the entire 84 month term has a required payment of $139.69. For the initial 12 months that payment strictly goes to the principal, and then from month 13 until the end of the term the payment stays the same but the amount is split between principal and interest. If the borrower is able to pay off the balance in 12 months she never has to pay interest, but if she is unable to do so she need only continue making the same payment of $139.69.

To calculate the payment the computer implemented method receives as inputs, either through the GUI or from the data source, the loan amount, the promotional rate(s) and term(s), and the regular rate and term. The method, by use of the computer system's processor (the “processor”), first amortizes the loan schedule using the loan amount, the regular rate, and the regular term in a conventional manner, i.e., it calculates the payment schedule as if this were a single fixed-rate loan at the regular rate for the regular term. The method, by use of the process, then uses that monthly payment in conjunction with the original loan amount and the promotional rate(s) and term(s) to calculate a revised amount financed. In other words, the method determines what amount would be financed if the fixed payment over the entire term was set at the fixed payment of the fully amortized schedule for the regular rate over the regular term.

Using an example whereby the inputs into the GUI include a loan amount of $10,000 over a 10 year period with the first 36 months having a rate of 5.99% and the remaining 84 months having a rate of 13.24%, the fixed monthly payment based on amortizing $10,000 over 84 months at 13.24% is $183.23. Applying this amount as the monthly payment over the promotional term of 36 months at the promotional rate of 5.99% leads to a revised amount financed of $14,382.60.

A loan scalar is then calculated, by processor, by dividing the original amount financed by the revised amount financed. In the previous example, the loan scalar is $10,000/$14,382.00=0.69528. The monthly payment then becomes $183.23×0.69528=127.39 over the entire life of the 120 month loan.

This computer implemented method may be applied to any number of rate and term combinations. If, for example, the first rate was 1.99% over a first term of 12 months, and the second term was for 24 months having a rate of 5.99%, with the regular term being 84 months at a rate of 13.24% as in the prior example, the revised amount financed is calculated by carrying the $183.23 monthly payment through both of the loan terms and adding principal based on the specified loan rates.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is an example GUI for use with the Computer Implemented Method.

FIG. 2 is an example system architecture for implementing the Computer Implemented Method.

FIG. 3 illustrates the key steps to the method

FIG. 4 illustrates the first step of the method.

FIG. 5 illustrates the second step of the method.

FIG. 6 illustrates the third step of the method.

FIG. 7 illustrates the fourth step of the method.

FIG. 8 is a table that illustrates the calculation of the revised financing amount.

FIG. 9 is a table that illustrates the final payment schedule.

FIG. 10 is a sample payment schedule for a multi-tier ascending loan package.

FIG. 11 is a sample payment schedule for a multi-tier descending loan package.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

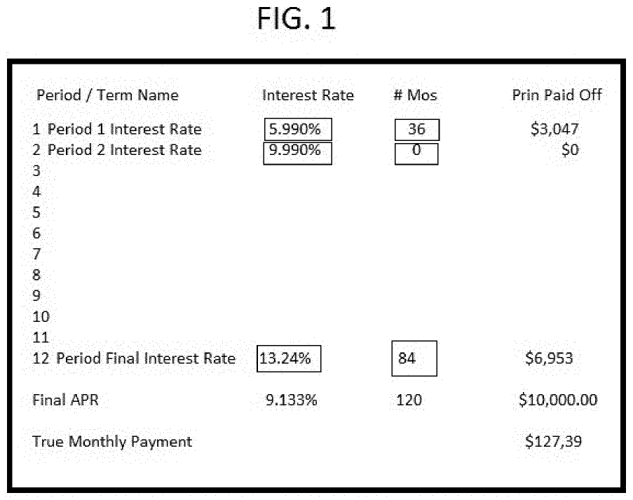

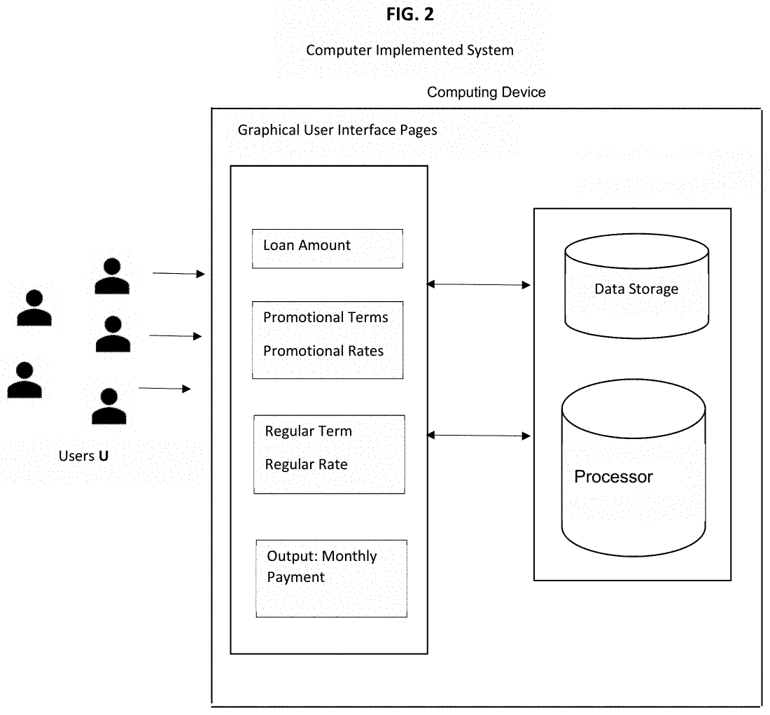

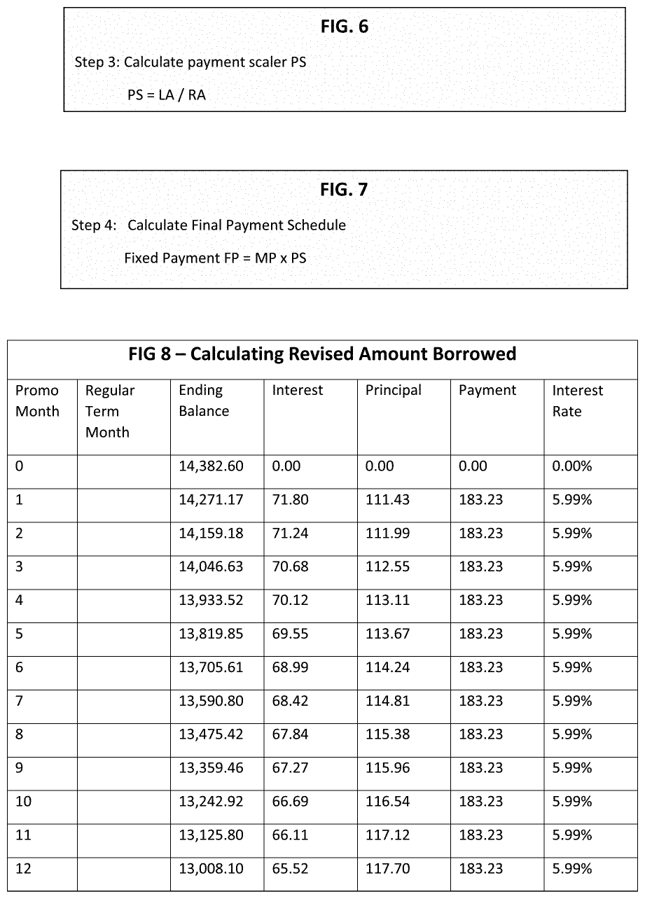

FIGS. 1-7 illustrate the computer system implement method 100 of providing a fixed-payment variable-rate loan package in real-time. The computer system includes one or more computing devices that has a processor and a graphical user interface (“GUI”), and that are able to receive user input, either entered from the GUI or retrieved from the data source, and transmit and receive data via a data source. Conventional programming means are used to implement the method and may be accomplished in a variety of manners using such conventional techniques.

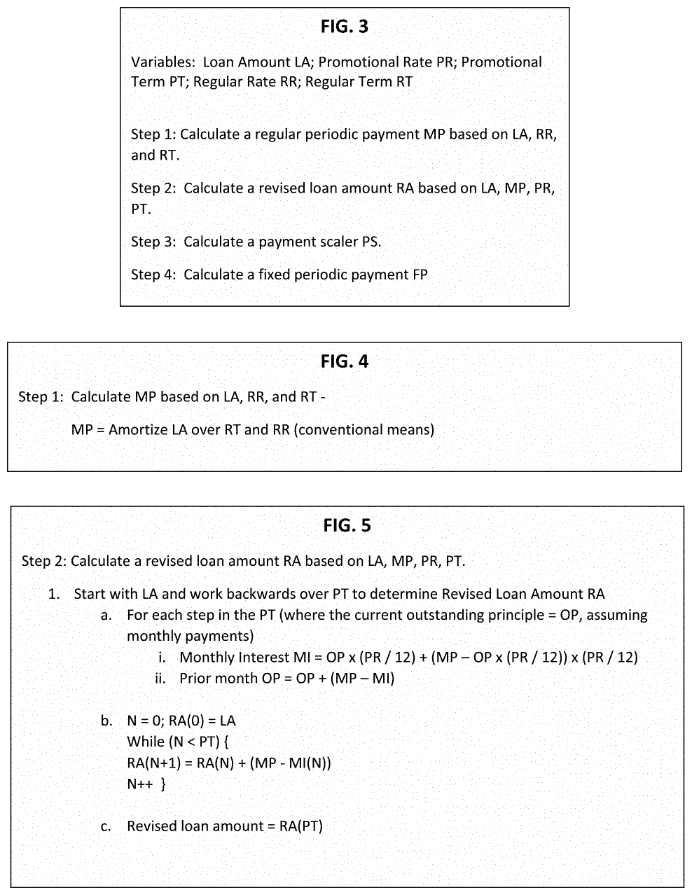

Inputs to the method, illustrated in FIG. 3 and either input through the GUI or retrieved from the data source, include a loan amount LA, at least one promotional rate PR and at least one corresponding promotional term PT, and one regular rate RR with a corresponding regular term RT. Using these inputs, the method, via the processor, calculates the fixed monthly payments across both the promotional term PT, or promotional terms PTs, and the regular term RT, and determines what total amount owed may be over the entirety of the promotional term and the regular term.

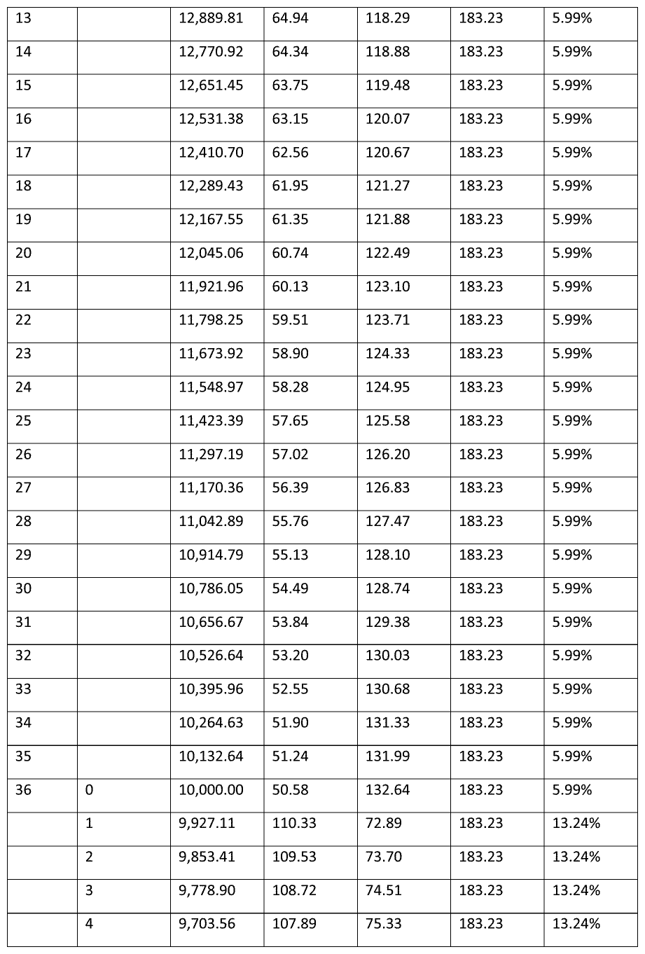

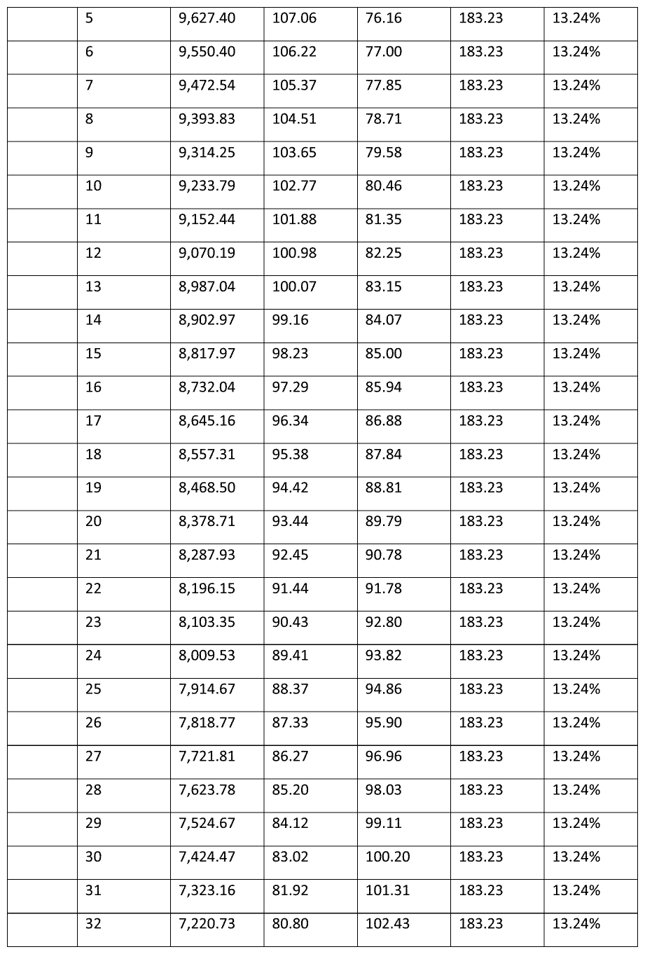

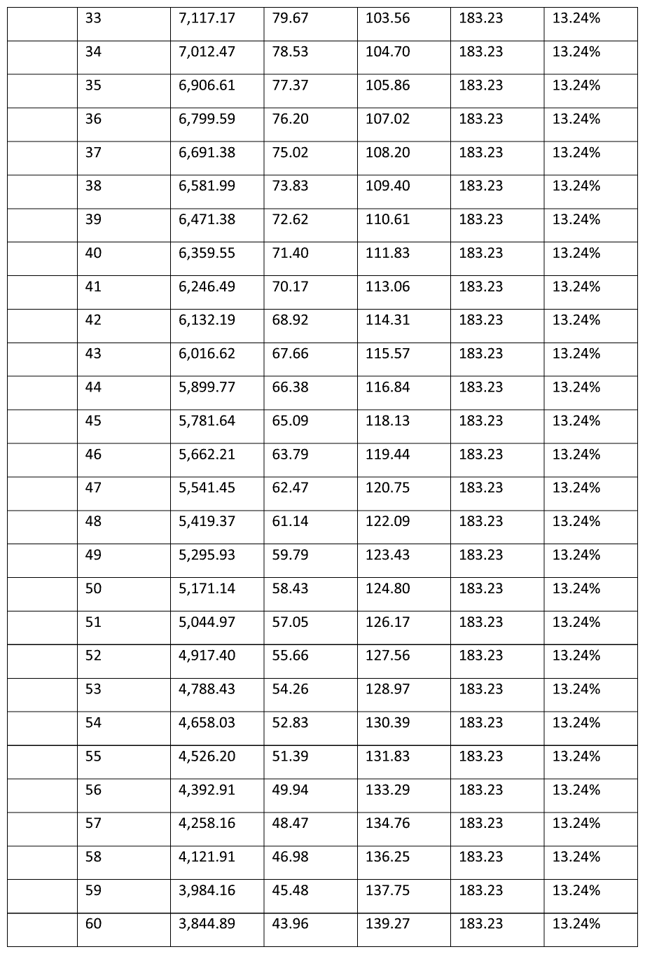

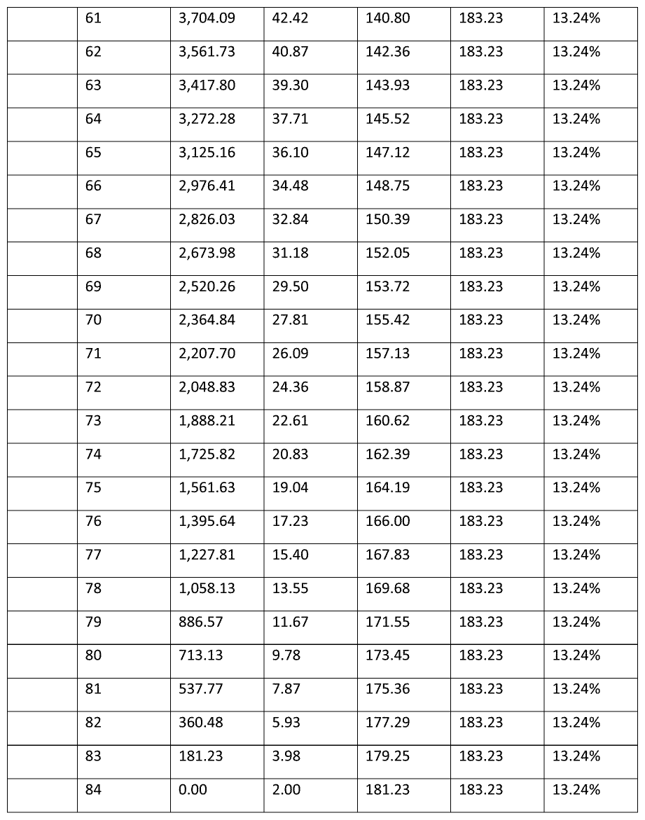

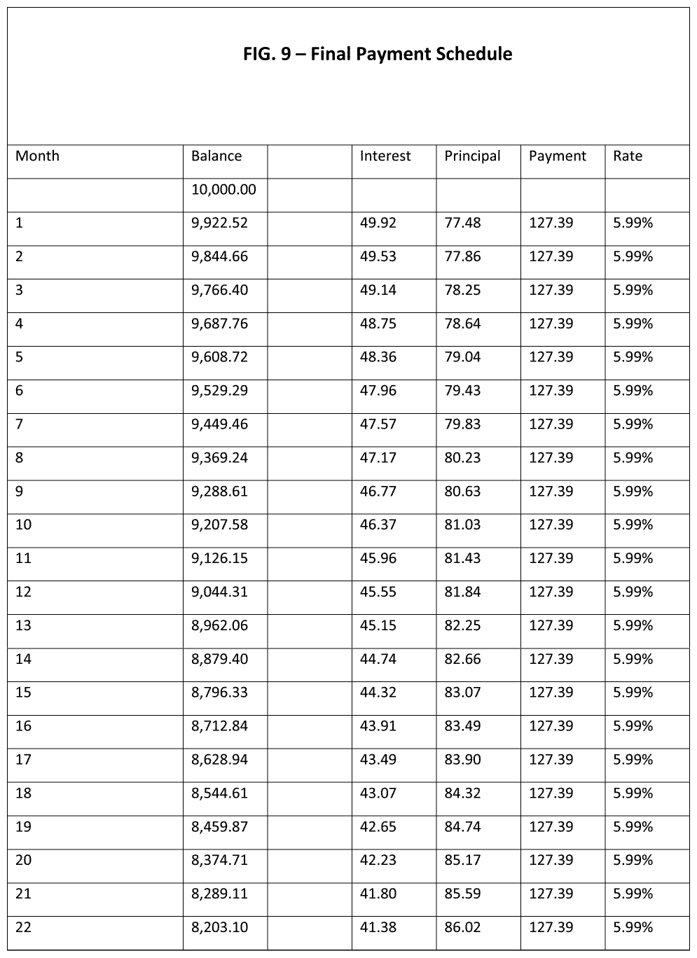

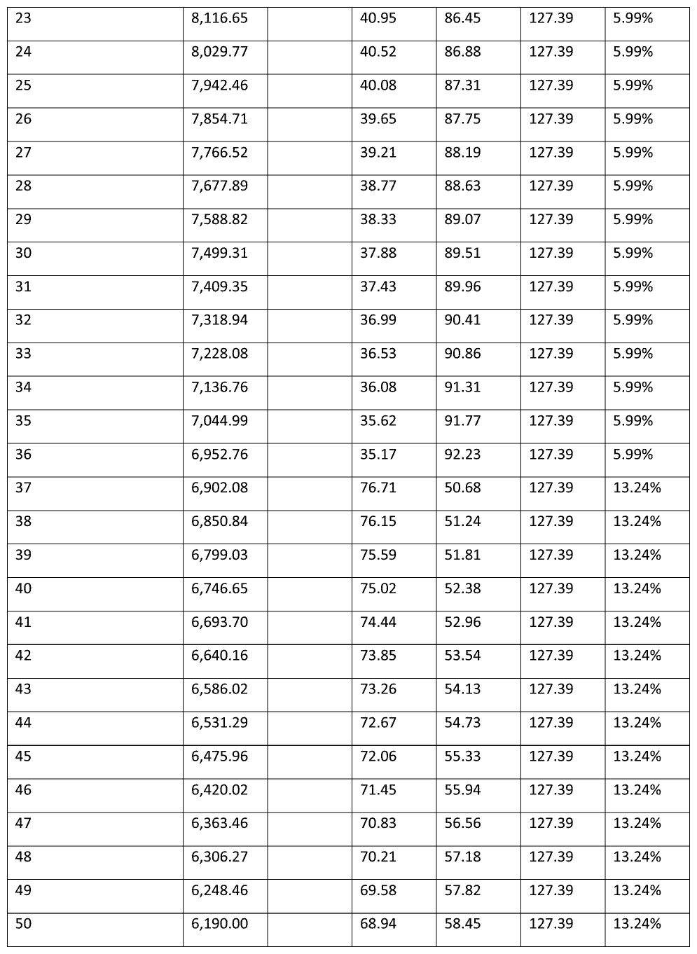

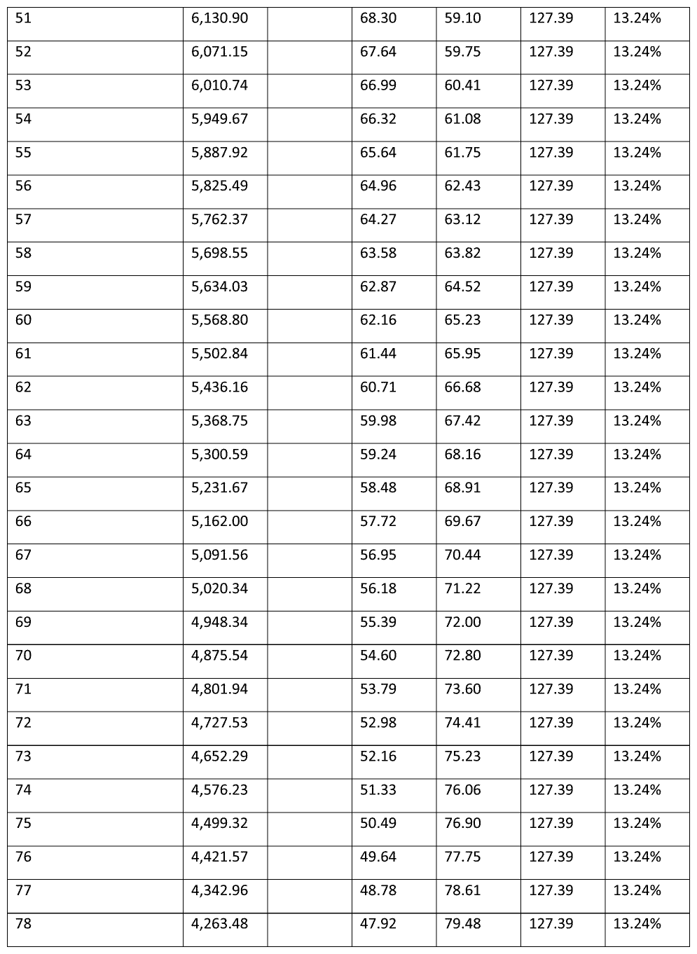

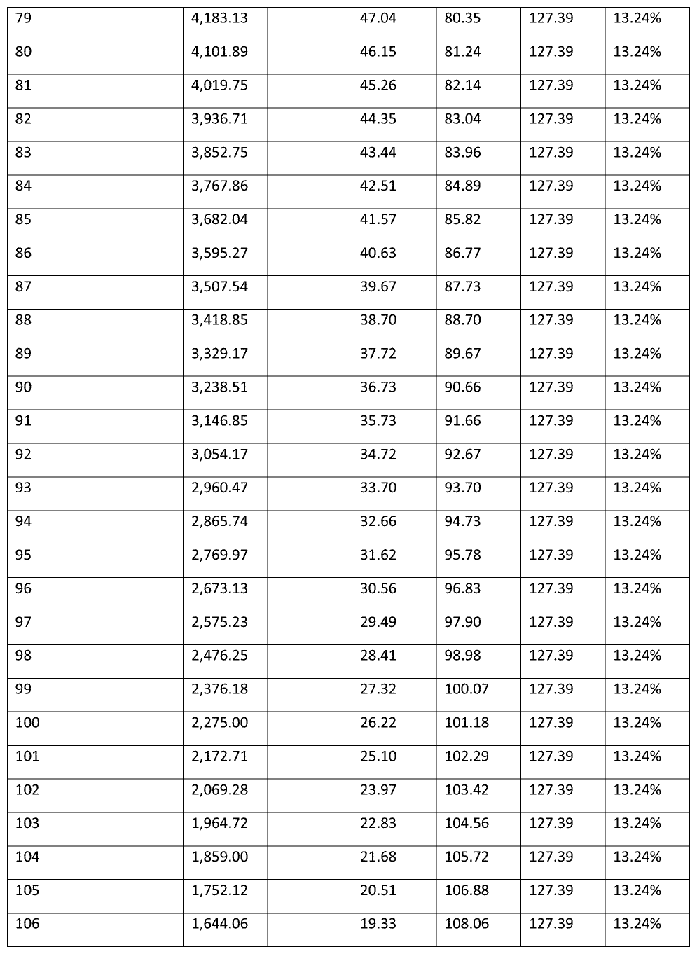

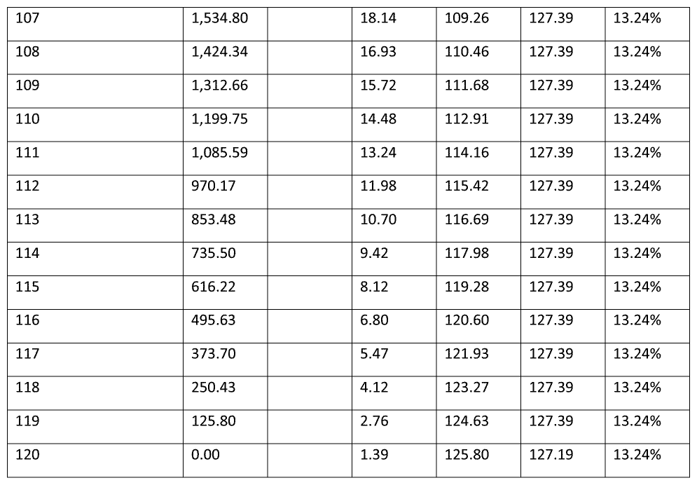

The description herein largely discusses the method in terms of it use for a loan package that has a relatively low initial rate that increases over time with payment due monthly, however, it is understand that the rates may also decrease over time and that any periodic time period may be used. Additionally, the description largely focuses on the method in terms of its use with loan payments that are made one per month and compounded annually, however, it is also understood that different payment periods and different compounding terms may be used. For example, the payments may be weekly, or the payments may be tied to a particular event such as the borrower's pay period (for example, semi-monthly or bi-weekly). Similarly, the compounding term may be annually, but it may also be monthly, daily, or any other suitable term. FIGS. 8 and 9, in particular, illustrate an example where a borrower wants to borrow $10,000 over a 10 year period, compounded annually, with the first 36 months having a rate of 5.99% and the remaining 84 months having a rate of 13.24%, with payment being made monthly; this scenario is used as an example to illustrate the broader concepts throughout the remaining description, but again this is but one example for illustration purposes and is in no way limiting.

The first step in the computer implemented method 100 is to amortize the loan amount LA over the length of the regular term RT using the regular rate RR to calculate a periodic payment MP, i.e. a monthly payment, using conventional amortization methods. For example, the periodic payment MP based on conventionally amortizing a loan amount LA of $10,000 over a regular term of 84 months, paid monthly and compounded annually, at regular rate of 13.24% is $183.23.

In the second step, illustrated in FIGS. 3 and 5, the method effectively works backwards starting with the loan amount LA to calculate a total amount owed that is used as the revised loan amount RA. The method 100 uses the periodic payment MP along with the promotional rate PR to calculate a periodic interest payment MIP that is owed during each period, e.g. month, of the promotional term PT. This step may be repeated for any number of promotional rates and promotional terms.

More specifically, to calculate the promotional term's PT periodic interest payment MIP, a periodic interest portion IP is calculated by dividing the promotional rate PR by period, e.g. 12 when the period is monthly for the number of months in a year:

IP=PR/12
For example, with a PR of 5.99%: IP=0.0599/12=0.004992

From there, the periodic interest payment MIP is calculated by multiplying an outstanding principal OP, which is initially set to the loan amount LA, by the periodic interest portion IP and subtracting that amount from the periodic payment MP, that result is multiplied by the periodic interest portion IP, and then that result is added to the result of multiplying the Outstanding Principal OP by the periodic interest portion IP. This formula may also be presented as follows:

MIP=OP×IP+(MP−OP×IP)×IP
For example:
   1st iteration:

50.58=10,000.00×0.004992 (183.23×10,000.00×0.0044992)×0.0044992

2^{nd} iteration:

51.21=10,132.65×0.004992 (183.23×10,132.65×0.0044992) ×0.0044992

Next, for each period in the promotional term PT, the outstanding principal OP is calculated by subtracting the previous period's periodic interest payment MIP from the periodic payment MP, and adding that amount to the previous months outstanding principal OP.

Current month OP=Prior Period OP+(MP−Prior Period MIP)

For example: 10,132.65=10,000.00+(183.23−50.58)

This step is repeated for each month in the promotional term PT to establish a revised loan amount RA:

N = 0; RA(0) = LA
While (N < PT) {
RA(N+1) = RA(N) + (MP − MI(N))
N++ }

For example, if this is carried out over a PT of 36 months for the previously stated example, the total RA(PT) is 14,382.60.

After completing these calculations for each step in the promotional term we have the revised loan amount RA, which is also referred to as the revised amount financed.

The third step is to calculate a periodic payment scalar PS by dividing the loan amount LA by the revised amount financed RA:

PS=LA/RA

For example: 10,000/14,382.60=.6953

The fourth steps is to calculate a fixed periodic payment FP is then calculated by multiplying the monthly payment MP by the payment scalar PS.

FP=MP×PS

For example: 183.23×6953=127.40, over the combined terms of RT+PT.

From the fixed periodic payment, the interest owed on each payment may be calculated by dividing the interest rate by the number of periods in a year, 12 for the case of monthly payments, and then multiplying that by the outstanding principal of the prior period.

The final result is a variable-rate fixed-payment loan that provides all of the benefits of the traditional variable rate loans without the payment spike that dooms so many borrowers.

As noted, this example is merely illustrative of one particular set of inputs.

In a second example, the rate may increase multiple times. If, for example, the first rate was 1.99% over a first period of 12 months, and the second period was for 24 months having a rate of 5.99%, with the regular term being 84 months at a rate of 13.24% as in the prior example, the revised amount financed is calculated by carrying the $183.23 monthly payment through all of the loan terms and adding principal based on the specified loan rates.

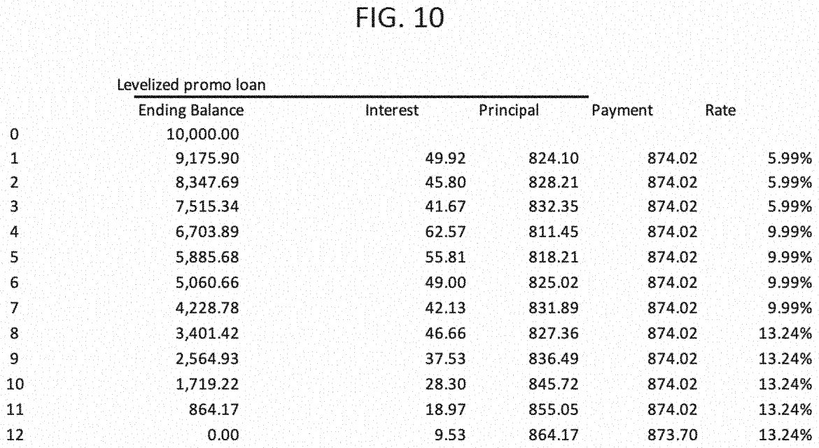

Specifically, the first step of amortizing the loan amount over the regular term at the regular rate remains the same, however, the second step of calculating a revised loan amount is repeated for each additional rate and each additional term. An example payment schedule following this model is shown in FIG. 10. More specifically, the step of:

N = 0; RA(0) = LA
While (N < PT) {
RA(N+1) = RA(N) + (MP − MI(N))
N++ }

Is carried out for each number of terms. For example, in the case of the scenario shown in FIG. 10 there are three rate/term periods: a regular rate of 13.24% over 5 months; a first promotion rate of 5.99% for 3 months; and a second promotional rate of 9.99% for 4 months. In this case, step two is repeated for each promotional terms/rates:

RA(0) = LA; x = 0; Promotional Terms = {3, 4}
For (i = 1; i < (number of promotional terms); i++)

N = 0; PT = Promotional Terms(i)
While (N < PT) {

RA(x+1) = RA(X) = (MP − MI(N))
X++; N++; }

}

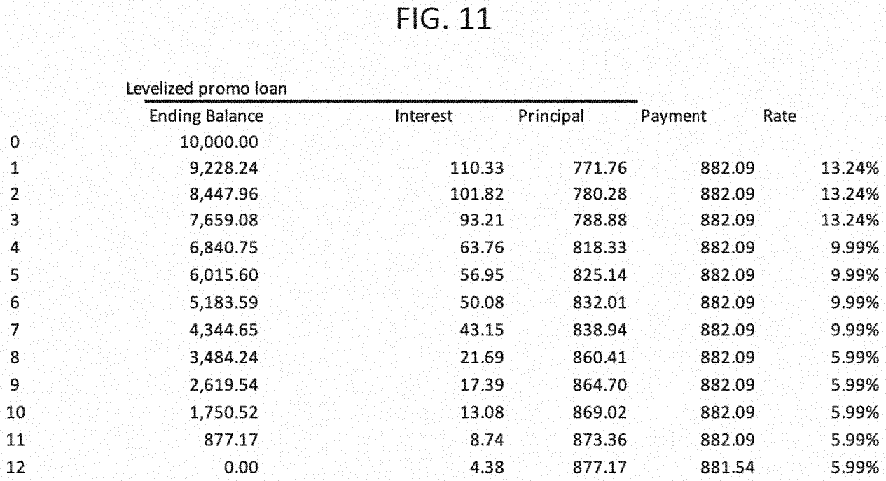

In another example, the loan rates may decrease rather than increase. For example, a loan where the rate drops every year on a five year loan. Such a loan package effectively rewards good payment performance by, for example, going from interest rate of 13% to 11% to 9% to 7% to 5% in each of years 1-5. Such a loan may help borrowers with less-than-perfect credit. Such a package may also benefit the financial institutions with retention, whereby the institution is more likely to hold on to borrowers who might go elsewhere to refinance once their payment history translated to a better credit score. FIG. 11 illustrates a sample payment schedule for a descending loan package.

As with conventional loans, the method may also allow so-called balloon payments that allow a borrower to pay-off the loan with a lump sum payment prior to the end of the term. Furthermore, the payments are not required to be evenly periodic over long durations.

As previously mentioned, the method is a computer implemented method that is executed on a computing device. The computing device is a conventional computer system having a conventional processor, such as a microprocessor, and having an operating system such as Microsoft Windows, Apple OS X, or a Linux distribution. The computing device may also be a mobile device such as a smart-phone, tablet, or personal digital assistant that likely uses an operating system such as iOS or DROID. The method may be implemented to run on the conventional computer system using a number of conventional programming techniques in a number of conventionally suitable programming languages. As such, the method may include computer-readable media encoded with a computer program, e.g. software, which includes instructions operable to cause the computing to perform methods of various embodiments. The software implementation, i.e., the computer-implemented method, may include microcode, assembly language code, or a higher- level language code, which further may include computer readable instructions for performing various methods. The code may form portions of computer program products. Further, the code may be tangibly stored on one or more volatile or non-volatile computer-readable media during execution or at other times. These computer-readable media may include, but not limited to, hard disks, removable magnetic disks, removable optical disks, memory cards or sticks, random access memories, read only memories, and other similar such technologies.

Various embodiments of the computer-implemented method implement the one or more software programs in various ways, including procedure-based techniques, component-based techniques, and/or object-oriented techniques, among others. Specific examples include C#, .NET and commercial class libraries. Those of ordinary skill in the art will appreciate that the hardware depicted herein may vary depending on the implementation. The depicted example is not meant to imply architectural limitations with respect to the present invention.

The computing device are configured to communicate with the data source using conventional means. For example, the data source may be a conventional database stored on a local hard drive or a networked hard drive, with communication carried via internal hardware or via a hardwired network. Alternatively, or in addition, the data source may also be cloud-based and communication may be carried out via a network using hardwired or wireless technologies.

If the method uses a network, that network may use any number of standard communication technologies, such as, for example, Ethernet, 802.11, 4G and/or 5G, digital subscriber lines, etc. Similarly, the network may use any number of standard communication protocols, such as, for example, transmission control protocol/internet protocol (TCP/IP), simple mail transfer protocol (SMTP), file transfer protocol (FTP), and/or the hypertext transport protocol (HTTP). The data being exchanged over the network may be represented using known technologies, such as hypertext markup language (HTML), and/or the extensible markup language (XML).

As used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

It is understood that the embodiments described herein are merely illustrative of the present invention. Variations in the steps of the computer implemented method of providing a fixed-payment variable-rate loan may be contemplated by one skilled in the art without limiting the intended scope of the invention herein disclosed and as defined by the following claims.

What is claimed is:

1: A computer system implemented method of providing a fixed-payment variable rate loan based on a loan amount entered through a graphical user interface, in real time, the method comprising the steps of:
receiving, via the graphical user interface, the loan amount;
receiving financial transaction data from a data source or through the graphical user interface, the financial transaction data including at least a promotional rate, a promotion term, a regular rate, and a regular term;
generating, by a processor, a periodic payment by amortizing the regular rate over the regular term;
calculating, by a processor, a revised loan amount that is the total amount owed over the regular term and the promotional term based the promotional rate, promotional term, regular rate, and regular term;
calculating, by a processor, a loan scalar by dividing the loan amount by the revised loan amount;
calculating, by a processor, a fixed periodic payment by dividing the periodic payment by the loan scalar.

2: The computer system implemented method of claim 1, further comprising the step of calculating, by a processor, a periodic interest payment for each period in the promotional term and saving in the data source the periodic interest payment for each period in the promotional term.

3: The computer system implemented method of claim 2, wherein the step of calculating, by processor, a periodic interest payment for each period in the promotional term includes the following steps:
generating, by processor, a periodic interest portion by retrieving the promotional rate from the data source and dividing the promotion rate by the number of periods in a year;
generating, by processor, an outstanding principal and initially setting the outstanding principal to the loan amount;
calculating, by processor, the periodic interest payment for each period in the promotional term by multiplying the outstanding principal by the periodic interest portion and adding that result to the result of the periodic interest payment subtracting the outstanding principal multiplied by the period interest portion, and multiplying that amount by the period interest portion.

4: The computer system implemented method of claim 3, wherein the step of calculating the outstanding principal for each period in the promotional term involves the following steps:
setting, by processor, the initial outstanding principal to be equal to the loan amount;
for each period in the promotional term following the first period in the promotional term, obtaining a prior period interest payment from the data source and obtaining a prior period's outstanding principal;
calculating, by processor, the outstanding principal for the current period by subtracting the prior period's interest payment from the periodic payment and adding that result to the prior period's outstanding principal;
storing the outstanding principal for each period in the data source.

5: The computer implemented method of claim 1, wherein the regular rate is an initial rate and the promotional rate is applied after the regular rate.

6: The computer implemented method of claim 1, wherein the promotional rate is an initial rate and the regular rate is applied after the promotional rate.

7: The computer implemented method of claim 1, wherein the financial transaction data includes multiple promotional terms and multiple promotional rates, and wherein each of the promotional terms in the multiple promotional terms is associated with a promotional rate from the multiple promotional rates.
